(19) United States
(12) Patent Application Publication
(10) Pub. No.: US 2026/0317132 A1
(43) Pub. Date: Oct. 15, 2026

(54) SWITCH, CAPSTAN DEVICE AND VEHICLE

(71) Applicant: T-MAX (HANGZHOU) TECHNOLOGY CO., LTD., Hangzhou (CN)

(72) Inventors: Hangfei YU, Hangzhou (CN); Taotao LI, Hangzhou (CN)

(21) Appl. No.: 19/174,754

(22) Filed: Apr. 9, 2025

(30) Foreign Application Priority Data
Mar. 18, 2024 (CN) 202420524529.2
Mar. 18, 2024 (CN) 202420524913.2
Mar. 18, 2024 (CN) 202420526263.5

(51) Int. Cl. B66D 1/48; B66D 1/12; H01H 47/00; H01H 50/02; H01H 50/14

(52) U.S. Cl. CPC B66D 1/485; B66D 1/12; H01H 47/002; H01H 50/021; H01H 50/14

(57) ABSTRACT

Disclosed are a switch, a winch device, and a vehicle. In some aspects, the switch includes a housing, a relay arranged in the housing and having a reset button for manually resetting the relay from outside the housing, and a control board arranged in the housing that includes a control chip, a timer, and a detection component, in which the detection component is configured to detect at least one of a current or a voltage of the relay. In some embodiments, the relay of the switch is coupled between a power source and an electrical device, so as to control the power supply to supply power to the electrical device.

### CROSS-REFERENCE TO RELATED APPLICATIONS

The present disclosure claims priority to and benefits of Chinese Patent Applications Serial No. 202420524529.2, 202420526263.5, and 202420524913.2, filed on Mar. 18, 2024. The entire contents of the aforementioned patent applications are incorporated by reference for all purposes.

### TECHNICAL FIELD

The present disclosure relates to a switch, a winch device, and a vehicle with the winch device.

### BACKGROUND

When an electrical device, especially a high-power electrical device such as a winch or capstan for vehicle rescue, is not in use, it is generally needed for a user to manually cut off the electrical connection between the electrical device (e.g., the winch) and the power source by unplugging the power plug of the electrical device or operating the switch between the control box of the electrical device and the power source. However, manual operations are troublesome and prone to being overlooked by users. In the related arts, a conventional automatic switch is arranged between a control box of the electrical device and the power source. However, the automatic switch is needed to couple with the control box via signal wires, thus resulting in more complex wiring. Moreover, the control box is needed to be used in conjunction with the automatic switch, thus impeding retrofitting of existing devices and limiting applications.

### SUMMARY

Disclosed are a switch, a winch device, and a vehicle. As described herein, a winch in accordance with the present technology may also be referred to as a capstan. Thus, the terms “winch” and “capstan” may be used interchangeably, and likewise the terms “winch device” and “capstan device” may be used interchangeably.

Some embodiments in accordance with the present technology provide a winch device that includes a winch, a control box and a switch. The winch includes a base frame, a rope drum rotatably mounted on the base frame, and a motor mounted on the base frame and coupled with the rope drum to drive the rope drum to rotate. The switch is configured to couple with a power source. The control box is coupled between the motor and the switch and includes a bridge relay for controlling the motor to rotate in a forward direction or a reverse direction. The switch includes a housing, a relay arranged in the housing and including a reset button for manually resetting the relay from outside the housing, and a control board arranged in the housing and including a control chip, a timer and a detection component, in which the detection component is configured to detect at least one of a current or voltage of the relay. The control chip is configured to control the relay to open in response to a value of at least one of the current or voltage detected by the detection component being lower than a preset value and to the timer having run for a preset period.

Some embodiments in accordance with the present technology provide a winch device that includes a winch and a control box. The winch includes a base frame, a rope drum rotatably mounted on the base frame, and a motor mounted on the base frame and coupled with the rope drum to drive the rope drum to rotate. The control box is coupled with the motor and includes a box body, a relay arranged in the box body to control the motor to rotate in a forward direction or a reverse direction, and a load detection component arranged in the box body and configured to detect a load state of the motor. The control box includes at least one additional wire having a first end arranged inside the box body and a second end, the second end of the additional wire being extended outside the box body or exposed from the box body, and being configured to be detachably coupled with an additional display for displaying the load state of the motor.

Some embodiments in accordance with the present technology provide a switch. The switch includes a housing, a relay arranged in the housing and including a reset button for manually resetting the relay from outside the housing, and a control board arranged in the housing and including a control chip, a timer and a detection component, the detection component being configured to detect at least one of a current or a voltage of the relay.

Some embodiments in accordance with the present technology provide a vehicle, including a vehicle body and a winch device mounted on the vehicle body.

### BRIEF DESCRIPTION OF THE DRAWINGS

FIG. 1 is a perspective view of a switch according to some embodiments of the disclosed technology.

FIG. 2 is another perspective view of a switch according to some embodiments of the disclosed technology.

FIG. 3 is an exploded view of a switch according to some embodiments of the disclosed technology.

FIG. 4 is a wiring diagram of a switch according to some embodiments of the disclosed technology.

FIG. 5 is a perspective view of a winch device according to some embodiments of the disclosed technology.

FIG. 6 is a block diagram of a winch device according to some embodiments of the disclosed technology.

FIG. 7 is a perspective view of a winch device according to some embodiments of the disclosed technology.

FIG. 8 is a perspective view of a winch of a winch device according to some embodiments of the disclosed technology.

FIG. 9 is a perspective view of a control box of a winch device according to some embodiments of the disclosed technology.

FIG. 10 is a perspective view of a control handle of a winch device according to some embodiments of the disclosed technology.

FIG. 11 is a perspective view of a vehicle according to some embodiments of the disclosed technology.

FIG. 12 is a perspective view of a vehicle according to some embodiments of the disclosed technology.

FIG. 13 is a perspective view of a vehicle according to some embodiments of the disclosed technology.

FIG. 14 is a perspective view of a vehicle according to some embodiments of the disclosed technology.

### DETAILED DESCRIPTION

The embodiments of the present technology are described in detail below, and examples of some of the embodiments are shown in the accompanying drawings. The embodiments described below with reference to the accompanying drawings are exemplary and intended to explain the present technology and should not be construed as limiting the disclosure.

Disclosed are a switch, a winch device, and a vehicle. As described herein, a winch in accordance with the present technology may also be referred to as a capstan. Thus, the terms “winch” and “capstan” may be used interchangeably, and likewise the terms “winch device” and “capstan device” may be used interchangeably.

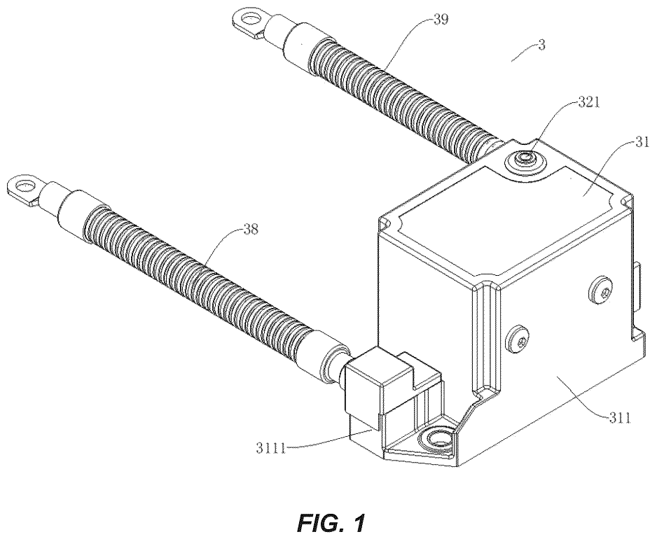

Embodiments of a switch 3 are described with reference to FIGS. 1 to 4.

As illustrated in FIGS. 1 to 4, the switch 3 includes a housing 31, a relay 32 and a control board 33. The relay 32 and the control board 32 are arranged in the housing 31.

The relay 32 is coupled between a power source 5 and an electrical device such as a winch, so as to control the power source 5 to supply power to the electrical device. The relay 32 has a reset button 321 for manually resetting the relay 32 from outside the housing 31.

The control board 33 includes a control chip 331, a timer 332 and a detection component 333. The detection component 333 is configured to detect at least one of a current or a voltage of the relay 32.

When the relay 32 is in a closed state, an electrical circuit between the power source 5 and the electrical device is conducting, and the power source 5 can supply power to the electrical device via the relay 32, thus enabling normal operation of the electrical device.

In such case, when the detection component 333 detects at least one of the current or the voltage of the relay 32, and at least one of a detected current value or voltage value is equal to or greater than a preset value, it indicates that the electrical device is in operation. Conversely, when the detection component 333 detects that at least one of the current value or voltage value of the relay 32 is lower than the preset value, or when the detection component 333 fails to detect at least one of the current or the voltage of the relay 32, it indicates that the electrical device is out of operation.

When the relay 32 is in an open state, the electrical circuit between the power source 5 and the electrical device is cut off, and the power source 5 is unable to supply power to the electrical device, thus ensuring electrical safety. In a case where a user needs to reactivate the electrical device, the user can manually operate the reset button 321 from outside the housing 31. The reset button 321 is configured to reset the relay 32 which is in the open state, causing the relay to switch back to the closed state, thus restoring power supply from the power source 5 to the electrical device and allowing the electrical device to operate normally again.

The control chip 331 is configured to control the switching of the relay 32 between the closed state and the open state based on a detection signal of the detection component 333. The timer 332 is configured for timing to achieve delayed power-off of the switch 3, thus adapting to scenarios where the user needs to use the electrical device repeatedly within a short period, and avoiding power-off when the user only pauses using the electrical device.

With the switch in the embodiment, the relay of the switch is coupled between the power source and the electrical device. By detecting at least one of the current or the voltage of the relay, the relay may be controlled to switch between the closed state and the open state, thus controlling the conducting or cutting off of the electrical circuit between the power source and the electrical device. Automatic electrical protection for the electrical device can be achieved without requiring additional signal wires coupled with the electrical device.

In some embodiment, the switch has a reasonable design, simple wiring, and compact structure, thus facilitating device modification, and demonstrating high applicability and wide application scope.

In some implementations, the control chip 331 is configured to control the relay 32 to open in response to a value of at least one of the current or voltage detected by the detection component 333 being lower than a preset value and in response to the timer 332 having run for a preset period, thereby cutting off the power supply from the power source 5 to the electrical device.

Specifically, the preset period of the timer 332 and at least one of a preset current value or a preset voltage value of the relay 32 are set. When the detection component 333 detects at least one of the current value of the relay 32 being lower than the preset current value, or the voltage value of the relay 32 being lower than the preset voltage value, the timer 332 starts timing. When the timer 332 has run for the preset period (e.g., the preset period is 10 minutes), that is, when at least one of the current value or the voltage value of the relay 32 has remained lower than the preset value for the preset period, it can be considered that the electrical device has stopped being used. Then, the control chip 331 controls the relay 32 to open, and the switch 3 is turned off, thereby cutting off the power supply from the power source 5 to the electrical device. The delayed power-off of the switch 3 is achieved by the use of the timer 332, thus adapting to scenarios where the user needs to use the electrical device repeatedly within a short period, and avoiding power-off when the user only pauses using the electrical device.

For example, the switch 3 is applied to a winch device serving as the electrical device, with a vehicle-mounted battery serving as the power source 5. The relay 32 is coupled between the vehicle-mounted battery and a control box of the winch device and used to control the power supply from the vehicle-mounted battery to a bridge relay of the control box.

When at least one of the current value or the voltage value detected by the detection component 333 is lower than the preset value and the timer 332 has run for the preset period, it can be considered that the winch has stopped being used. Then, the control chip 331 may control the relay 32 to open, thereby cutting off the power supply from the vehicle-mounted battery to the bridge relay. The winch device is thus powered off.

When the winch device needs to be reactivated, the user can manually operate the reset button 321 to reset the relay 32, so as to re-close the relay 32. The switch 3 is turned on, and the electrical circuit conducts, thereby restoring the power supply from the vehicle-mounted battery to the bridge relay and allowing the winch device to operate normally again.

In some embodiments, the preset current value of the relay 32 is set, and the control chip 331 controls the relay 32 to open in response to the current value detected by the detection component 333 being lower than the preset current value and the timer 332 having run for the preset period.

In some embodiments, the preset voltage value of the relay 32 is set, and the control chip 331 controls the relay 32 to open in response to the voltage value detected by the detection component 333 being lower than the preset voltage value and the timer 332 having run for the preset period.

In some embodiments, the preset current value and the preset voltage value of the relay 32 are set, and the control chip 331 controls the relay 32 to open in response to the current value detected by the detection component 333 being lower than the preset current value, the voltage value detected by the detection component 333 being lower than the preset voltage value, and the timer 332 having run for the preset period.

In some embodiments, when the value of at least one of the current or voltage detected by the detection component 333 exceeds the preset value within the preset period, the control chip 331 controls the timer 332 to restart timing. In other words, when the detection component 333 detects that at least one of the current value or the voltage value of the relay 32 is lower than the corresponding preset value, the timer 332 starts timing. When the running time of the timer 332 does not exceed the preset period, and the detection component 333 detects that at least one of the current value or the voltage value of the relay 32 exceeds the corresponding preset value, it indicates that the user restarts the electrical device. The timing of the timer 332 then is reset to zero. When at least one of the current value or the voltage value detected by the detection component 333 is lower than the corresponding preset value, the timing of the timer 332 restarts.

For example, the preset current value and the preset voltage value of the relay 32 are set. When at least one of the current value and the voltage value detected by the detection component 333 exceeds the corresponding preset value within the preset period, the control chip 331 resets the timer 332 to zero. When at least one of the current value and the voltage value detected by the detection component 333 is lower than the corresponding preset value, the timing of the timer 332 restarts.

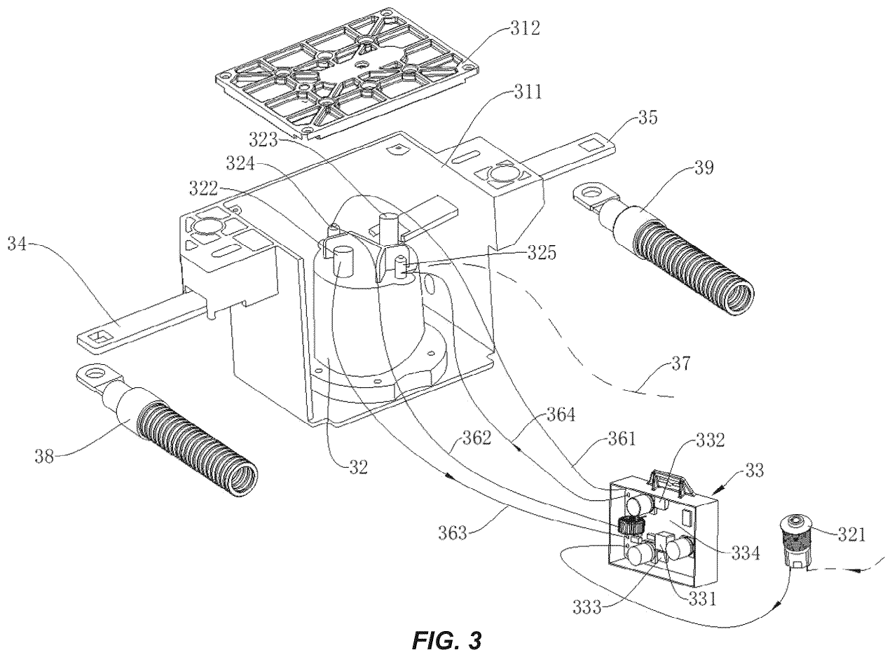

In some embodiments, as illustrated in FIG. 3, the control board 33 includes a base panel 334. The control chip 331, the timer 332, and the detection component 333 are arranged or integrated onto the base panel 334, and a signal connection among the control chip 331, the timer 332, and the detection component 333 is achieved via the base panel 334, which enhances an integration level of the control board 33, thereby reducing the number of wires, lowering circuit complexity, and facilitating equipment maintenance.

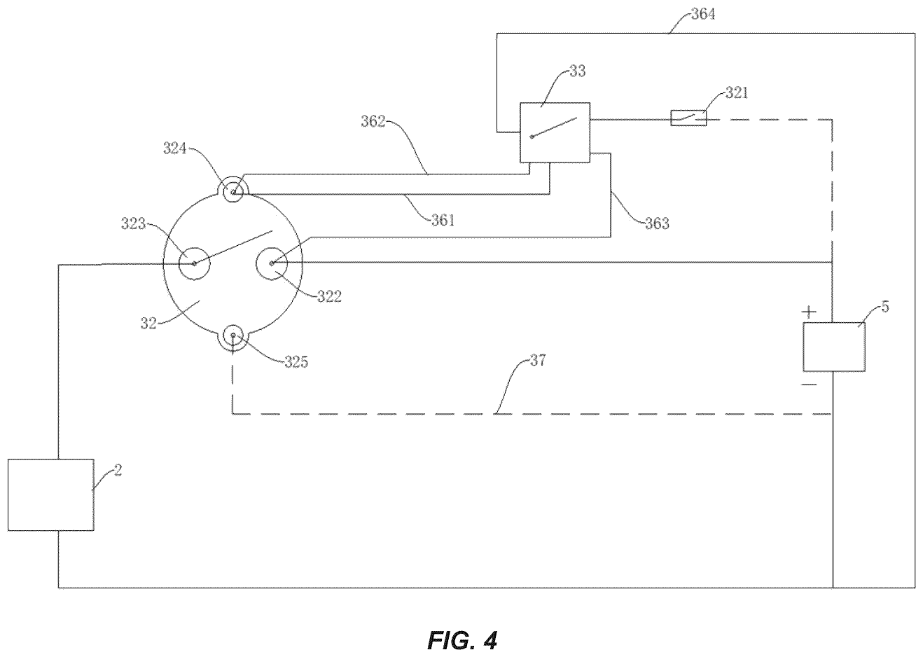

In some embodiments, as illustrated in FIG. 3 and FIG. 4, the relay 32 has a first terminal 322, a second terminal 323, a third terminal 324, and a fourth terminal 325. The switch 3 further includes a wire-incoming terminal 34 and a wire-outgoing terminal 35.

The wire-incoming terminal 34 includes a wire-incoming inner end and a wire-incoming outer end. The wire-incoming inner end is arranged within the housing 31 and is coupled with the first terminal 322, and the wire-incoming outer end is arranged outside the housing 31 and is configured to be coupled with a positive electrode of the power source 5.

The wire-outgoing terminal 35 has a wire-outgoing inner end and a wire-outgoing outer end. The wire-outgoing inner end is arranged within the housing 31 and is coupled with the second terminal 323, and the wire-outgoing outer end is arranged outside the housing 31 and is coupled with a control box 2.

The fourth terminal 325 is coupled with a negative electrode of the power source 5 via a grounding wire 37. The relay 32 is thus coupled between the power source 5 and the control box 2 and is used to control the power source 5 to supply power to the control box 2. When the relay 32 is closed, the power source 5 supplies power to the control box 2, so that the electrical device can operate normally. When the relay 32 is open, the power source 5 is cut off to supply power to the control box 2, and the electrical device cannot operate.

As illustrated in FIG. 3 and FIG. 4, the control board 33 is coupled with the third terminal 324 via a control wire 361 and a detection wire 362. The control wire 361 is used to transmit control signals, so as to control the switching of the relay 32 between the closed state and the open state.

Specifically, the control wire 361 can be coupled with the control chip 331 of the control board 33, and the control chip 331 controls the relay 32 to be closed or open via the control wire 361. The detection wire 362 is used to transmit at least one of a current detection signal or a voltage detection signal of the relay 32. The detection wire 362 can be coupled with the detection component 333 which detects at least one of the current or the voltage of the relay 32 and transmits at least one of the current detection signal or the voltage detection signal of the relay 32 to the control chip 331 via the detection wire 362. The control chip 331 then generates a control signal based on at least one of the current detection signal or the voltage detection signal received, and sends the control signal to the relay 32 via the control wire 361.

The power supply to the control board 33 can be achieved through an external power source. In some examples, in order to reduce the number of components, both the control board 33 and the relay 32 are coupled with the power source 5.

As illustrated in FIG. 3 and FIG. 4, the control board 33 is coupled with the first terminal 322 via a power supply wire 363 of the control board 33. Since the first terminal 322 is coupled with the positive electrode of the power source 5, the control board 33 is thus coupled with the positive electrode of the power source 5. The control board 33 is coupled with the fourth terminal 325 via a negative electrode wire 364. Since the fourth terminal 325 is coupled with the negative electrode of the power source 5 via the grounding wire 37, the control board 33 is thus coupled with the negative electrode of the power source 5.

In this way, the control board 33 is coupled with the power source 5, and the power source can supply power to the control chip 331, the timer 332, and the detection component 333 of the control board 33. The control board 33 is coupled with the relay 32, thus reducing the length of power supply wires and decreasing the wiring complexity. In other examples, the control board 33 may be coupled with other power sources for power supply, or the control board 33 may be directly coupled with the positive and negative electrodes of the power source 5 via power supply wires, without passing through the relay 32.

As illustrated in FIG. 3 and FIG. 4, the reset button 321 is coupled between the control board 33 and the positive electrode of the power source 5. Therefore, the control board 33 and the positive electrode of the power source 5 can be coupled via the closed reset button 321. When the electrical device needs to be activated, the user can press the reset button 321 to close the reset button 321. The control chip 331 controls the relay 32 to be closed via the control wire 361, and the electrical circuit is thus conducting. The power source 5 can supply power to the control box 2, and the electrical device can operate normally.

As illustrated in FIG. 3, the switch 3 further includes a wire-incoming connection member 38 having a first end and a second end, and a wire-outgoing connection member 39 having a first end and a second end. The first end of the wire-incoming connection member 38 is coupled with the wire-incoming outer end of the wire-incoming terminal 34, and the second end of the wire-incoming connection member 38 is coupled with the positive electrode of the power source 5. The first end of the wire-outgoing connection member 39 is coupled with the wire-outgoing outer end of the wire-outgoing terminal 35, and the second end of the wire-outgoing connection member 39 is coupled with the control box 2.

Specifically, as illustrated in FIGS. 1-3, the housing 31 of the switch 3 includes a switch enclosure 311 and a bottom plate 312. A bottom surface and one side surface of the switch enclosure 311 are open. The bottom plate 312 is detachably mounted onto the bottom surface of the switch enclosure 311 to close the bottom surface of the switch enclosure 311.

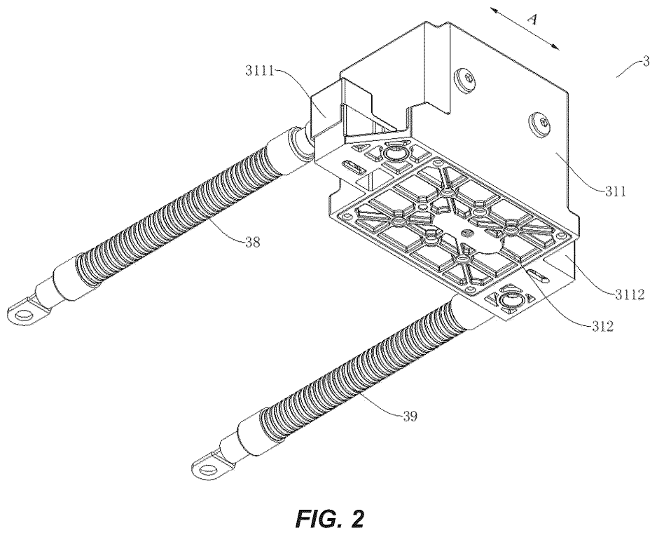

As illustrated in FIG. 3, the switch enclosure 311 has a first side surface and a second side surface which are opposite in a first direction (such as a direction illustrated by an arrow A in FIG. 2). The first side surface and the second side surface of the switch enclosure 311 are adjacent to the open side surface of the switch enclosure 311. A first reinforcement platform 3111 is arranged on the first side surface of the switch enclosure 311 for supporting the wire-incoming terminal 34, and a second reinforcement platform 3112 is arranged on the second side surface of the switch enclosure 311 for supporting the wire-outgoing terminal 35.

As illustrated in FIG. 3 and FIG. 4, the housing 31 has a first side and a second side opposite to the first side in the first direction. The wire-incoming outer end of the wire-incoming terminal 34 is extended out of the housing 31 from the first side of the housing 31 in the first direction, and the wire-outgoing outer end of the wire-outgoing terminal 35 is extended out of the housing 31 from the second side of the housing 31 in the first direction.

The wire-incoming connection member 38 and the wire-outgoing connection member 39 have a cylindrical shape, extended parallel in the same direction from the housing 31, and spaced apart from each other via an interval. An extending direction of the wire-incoming connection member 38 and the wire-outgoing connection member 39 is perpendicular to an extending direction (i.e., the first direction) of the wire-incoming terminal 34 and the wire-outgoing terminal 35.

As illustrated in FIG. 3, the first terminal 322, the second terminal 323, the thi terminal 324, and the fourth terminal 325 of the relay 32 face towards the bottom surface of switch enclosure 311. The reset button 321 is exposed from a top surface of the switch enclosure 311.

A winch is generally used for rescuing vehicles, ships, etc. A control box of the winch includes a bridge relay coupled with a power source (such as a vehicle-mounted battery) for controlling the winch to rotate in a forward direction or a reverse direction.

Typically, for conventional capstans, a switch is usually arranged between the bridge relay and the power source. When using the conventional winch, the user needs to manually operate the switch to couple the bridge relay and the power source to supply power to the bridge relay. When stopping using the conventional winch, the user needs to manually operate the switch to cut off the power supply to the bridge relay from the power source. However, after using the winch, the user usually does not manually operate or forget to manually operate the switch, thus resulting in the bridge relay being continuously charged. Moreover, the user needs to frequently manually operate the switch when using a conventional winch, which makes operations more troublesome and causes a motor of the winch to start frequently.

In the related arts, an automatic switch is generally connected between the bridge relay and the power source, as well as a load detection module is generally arranged in the control box of the winch. In such winches, the load detection module in the control box is coupled with the automatic switch and the motor of the winch via a signal wire. A control board in the control box controls the automatic switch to be closed and open based on a motor load detected by the load detection module. In such cases, the load detection module in the control box needs to be coupled with the automatic switch and the motor via the signal wire, which results in complex wiring. Moreover, the control box needs to be used in conjunction with the automatic switch, thereby impeding retrofitting of existing devices and limiting practical applications.

Disclosed are embodiments of winch devices in accordance with the present technology that can resolve such technical problems in the related arts.

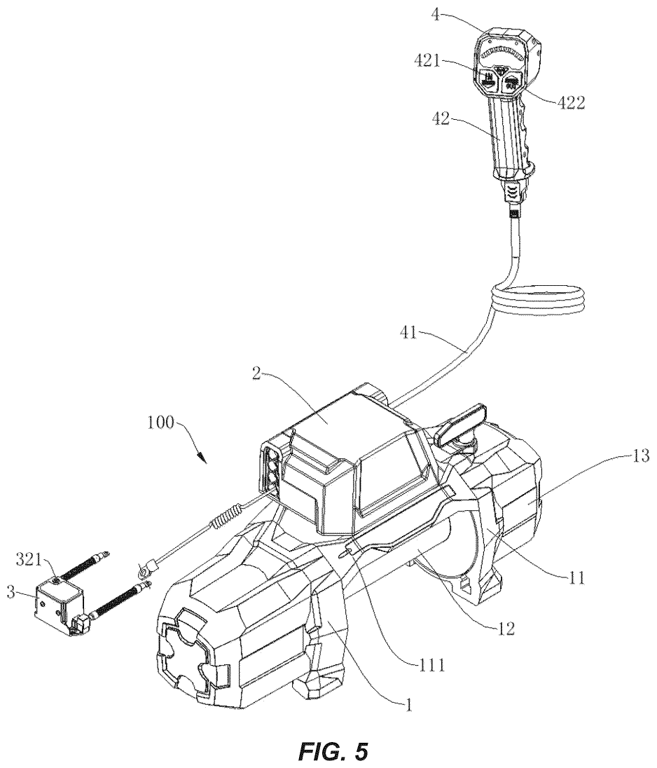

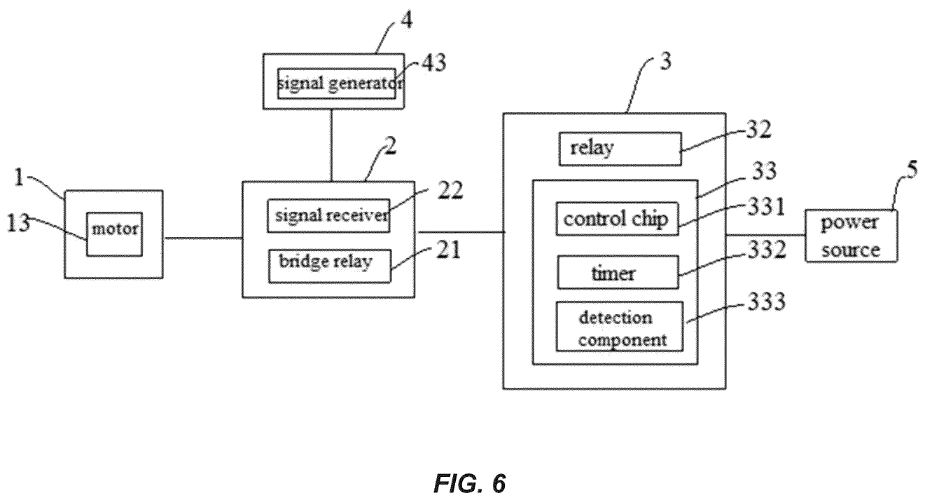

A winch device 100 of embodiments of the disclosure is described with reference to FIGS. 5 to 6.

As illustrated in FIG. 5 and FIG. 6, the winch device 100 includes a winch 1, control box 2 and a switch 3, in which the switch 3 may be the switch according to above embodiment.

The winch 1 includes a base frame 11, a rope drum 12 and a motor 13. The rope drum 12 is rotatably mounted on the base frame 11, and the motor 13 is mounted on the base frame 11 and coupled with the rope drum 12 to drive the rope drum 12 to rotate. The rope drum 12 is configured to wind a rope, and the motor 13 drives the rope drum 12 to rotate so as to wind the rope onto the rope drum 12 or unwind the rope from the rope drum 12.

The control box 2 is coupled between the motor 13 and the switch 3. The control box 2 includes a bridge relay 21 configured to control the motor 13 to rotate in a forward direction or a reverse direction. For example, the bridge relay 21 controls the motor 13 to rotate in the forward direction, and the rope drum 12 unwinds the rope. The bridge relay 21 controls the motor 13 to rotate in the reverse direction, and the rope drum 12 winds the released rope.

The switch 3 is coupled with the control box 2 and configured to couple with the power source 5. The switch 3 is configured to control the power source 5 to supply power to the bridge relay 21. For example, the power source 5 may be a vehicle-mounted battery. The switch 3 includes a housing 31, a relay 32, and a control board 33, with the relay 32 and the control board 33 arranged in the housing 31. The control board 33 includes a control chip 331, a timer 332, and a detection component 333.

The detection component 333 is configured to detect at least one of a current or a voltage of the relay 32. The control chip 331 is configured to control the relay 32 to open in response to a value of at least one of the current or voltage detected by the detection component 333 being lower than a preset value and in response to the timer 332 having run for a preset period, thereby cutting off the power supply from the power source 5 to the bridge relay 21.

The preset period of the timer 332 and at least one of a preset current value or a preset voltage value of the relay 32 are set, when the detection component 333 detects that at least one of the current value of the relay 32 is lower than the preset current value, or the voltage value of the relay 32 is lower than the preset voltage value, the timer 332 starts timing. When the timer 332 has run for the preset period (e.g., the preset period is 10 minutes), that is, when at least one of the current value or the voltage value of the relay 32 has remained lower than the preset value for the preset period, it means that the winch 1 has stopped being used. Then, the control chip 331 controls the relay 32 to open, and the switch 3 is turned off, thereby cutting off the power supply from the power source 5 to the bridge relay 21. The delayed power-off of the switch 3 is achieved by using the timer 332, thereby adapting to scenarios where the user needs to use the winch 1 repeatedly within a short period, and avoiding power-off when the user only pauses using the winch 1.

The relay 32 has a reset button 321 for manually resetting the relay 32 from outside the housing 31. When the relay 32 is in an open state, the power source 5 stops supplying power to the bridge relay 21, and the winch 1 cannot be activated. When it is needed to reactivate the winch 1, the user operates the reset button 321 to reset the relay 32. Then the switch 3 is turned on, and the electrical circuit conducts, thereby restoring power supply from the power source 5 to the bridge relay 21. The winch 1 can operate normally.

With the winch device in the embodiments, the switch is arranged between the bridge relay and the power source, and the switch includes the relay and the control board. When the control board detects that at least one of the current value or the voltage value of the relay remains below the preset value within the preset period, the control board controls the relay to disconnect from the power source, thereby cutting off the power supply from the power source to the bridge relay, and achieving automatic power-off protection of the winch device. The winch device has a reasonable design, a simple structure and simple wiring, facilitates device modification, and demonstrates high applicability and wide application scope.

In some embodiments, as illustrated in FIG. 5 and FIG. 6, the winch device 100 further includes a control handle 4. The control handle 4 is configured for controlling an operation of the winch 1, and the control handle 4 may be wired to or wirelessly coupled with the control box 2. The user holds and operates the control handle 4, which is more flexible and convenient. For example, the user can adjust their position to observe conveniently an operation situation at any time and timely operate the winch 1 via the control handle 4.

In the example shown in FIG. 5, the control handle 4 is wired to the control box 2. The control handle 4 includes a handle body 42 and a handle wire 41. There are several buttons or knobs on the handle body 42 for control. The user holds the handle body 42 to operate the winch 1. A first end of the handle wire 41 extends into the handle body 42, and a second end of the handle wire 41 extends outside the handle body 42. The second end of the handle wire 41 is provided with a handle terminal, and the control box 2 is provided with a handle port. The handle terminal of the control handle 4 is removably insertable into the handle port of the control box 2. When there is no need to use the control handle 4, the handle terminal can be separated from the handle port.

As illustrated in FIG. 5, the handle body 42 has an IN button 421 and an OUT button 422. The user can press the IN button 421 to control the winch 1 to wind the rope, and press the OUT button 422 to control the winch 1 to unwind the rope wound on the rope drum 12. It is convenient and quick for users to operate. In other examples, buttons used for other operations may also be arranged on the handle body 42.

In the example shown in FIG. 6, the control handle 4 is wirelessly coupled with the control box 2. The control handle 4 includes a signal generator 43 for emitting control signals, and the control box 2 includes a signal receiver 22 wirelessly communicating with the signal generator 43. The signal receiver 22 is configured to receive the control signals emitted by the signal generator 43. When the user operates the control handle 4, the control handle 4 sends a wireless signal to the control box 2. After receiving the wireless signal, the control box 2 controls the operation of the winch 1. The control handle 4 is wirelessly coupled with the control box 2, allowing users to remotely activate the winch 1, and enhancing the user experience.

In order to monitor a winch state (such as a load state of a motor of the winch) in real-time during use, which is convenient for the user to make judgments to continue running or stop the winch, a display is usually arranged to display the load state.

In related arts, the display is usually arranged on a control box of the winch and fixedly coupled with a control board inside the control box via wires. Conventionally, the control box is mounted on the winch, so it is inconvenient for the user to observe the display. Especially, during the operation of the winch, the user is usually far away from the winch, which makes it even more difficult for the user to observe the display. In particular, when the winch is mounted inconspicuously on the vehicle, it is more difficult for the user to observe the display, which affects the user's judgements and operation. In addition, after the winch is manufactured in the factory, the mounting position of the display is fixed and cannot be changed. The user cannot change the mounting position of the display according to subsequent needs, and functions of the display in the related arts are limited, which affects the user experience.

Disclosed are embodiments of winch devices in accordance with the present technology that can resolve such technical problems in the related arts.

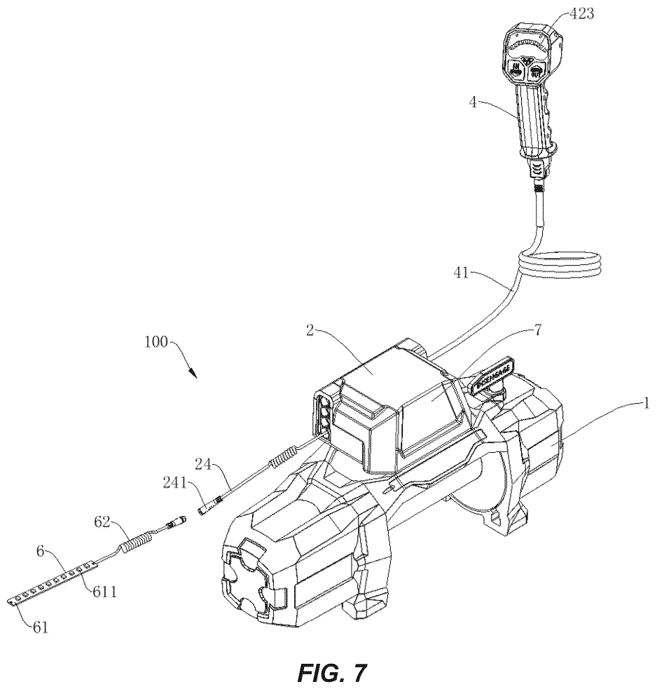

A winch device 100 according to another embodiment will be described with reference to FIGS. 7 to 10.

As illustrated in FIGS. 7 to 10, the winch device 100 includes a winch 1 and control box 2.

The winch 1 includes a base frame 11, a rope drum 12 and a motor 13. The rope drum 12 is rotatably mounted on the base frame 11, and the motor 13 is mounted on the base frame 11 and coupled with the rope drum 12 to drive the rope drum 12 to rotate. The rope drum 12 is configured to wind a rope, and the motor 13 drives the rope drum 12 to rotate, so as to wind the rope onto the rope drum 12 or unwind the rope from the rope drum 12.

The control box 2 is coupled with the motor 13 and includes a box body 23, a bridge relay (not shown in the figures), and a load detection component (not shown in the figure). The bridge relay is arranged inside the box body 23 and is configured to control the motor 13 to rotate in a forward direction or a reverse direction. For example, when the bridge relay controls the motor 13 to rotate in the forward direction, the rope drum 12 unwinds the rope. When the bridge relay controls the motor 13 to rotate in the reverse direction, the rope drum 12 winds the winch rope. The load detection component is arranged in the box body 23 and is configured to detect a load state of the motor 13. The load state of the motor 13 refers to its operating state under load, where an output power of the motor 13 is greater than in a no-load state. The load of the motor 13 represents the mechanical burden the motor 13 bears. For example, when the winch rope is connected with an object to be towed, the motor 13 drives the rope drum 12 to rotate, so as to wind the rope, thereby towing or lifting the object. At this time, the motor 13 operates under load. The load detection component can detect a magnitude of the load borne by the motor 13.

The control box 2 includes at least one additional wire 24 having a first end and a second end 241. The first end of the additional wire 24 is arranged inside the box body 23, and the second end 241 of the additional wire 24 is extended outside the box body 23 and is configured to be detachably coupled with an additional display 6 for displaying the load state of the motor 13. Alternatively, the second end 241 of the additional wire 24 is exposed from the box body 23 and is configured to be detachably coupled with the additional display 6. The load detection component is in signal connection with the additional display 6 and can transmit a load detection signal of the motor 13 to the additional display 6, which can display the load state of the motor 13.

When the second end 241 of the additional wire 24 extends outside the box body 23, a part of the additional wire 24 is arranged inside the box body 23, and the other part is arranged outside the box body 23. When the second end 241 of the additional wire 24 is exposed from the box body 23, the additional wire 24 is arranged inside the box body 23.

Since the control box 2 and the additional display 6 can be coupled by a connecting wire with a set length, and a mounting position of the additional display 6 can be flexibly chosen and easily changed. For example, the additional display 6 can be mounted at any position on a front bumper, a grille, or a hood of a vehicle, which enables users to easily observe the load state of the motor 13 and to make judgments and operations timely.

The winch device in the above embodiments includes the additional display for providing real-time feedback on the current operating state of the winch. The additional display, with high mounting flexibility, can be mounted at a visible position on the vehicle, so as to make it easier for the user to observe intuitively the working state of the winch from a distance. It effectively solves the problem in the related arts where the display is mounted inconspicuously, making it difficult for the user to observe the display.

The user can more intuitively and accurately know the operating state of the winch, so as to make timely judgments to continue running or to stop the winch, protect the motor, avoid a long-term overloaded operation of the motor, prolong a service life of the motor, and improve a usage safety of the winch device. In addition, the user can reasonably allocate the number and mounting position of additional displays according to operation requirements, effectively solving the problem of visual blind spots, and making the use of the winch device more flexible and convenient.

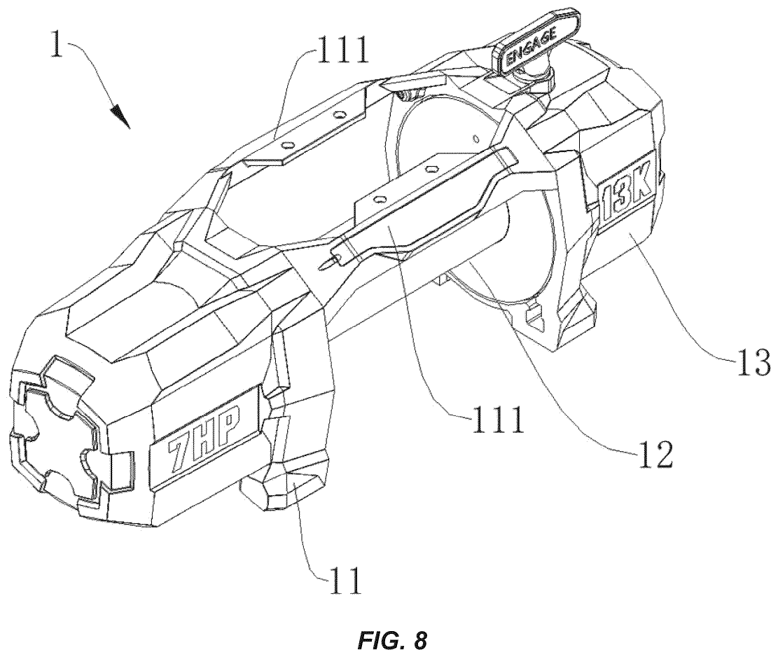

In some examples, as illustrated in FIGS. 7 and 8, the rope drum 12 has a first end and a second end, which are opposite to each other in an axial direction of the rope drum 12, and are rotatably supported on the base frame 11 of the winch 1. The winch rope is wound around the rope drum 12, and is unwound or wound as the rope drum 12 rotates. The base frame 11 further includes a plurality of protection frames 111 arranged around the rope drum 12 and configured to protect the winch rope wound around the rope drum 12. The motor 13 is mounted inside the base frame 11. A motor shaft of the motor 13 is coupled with the first end of the rope drum 12 to drive the rope drum 12 to rotate. A plurality of connection ports (not shown in the figure) of the motor 13 are exposed from the base frame 11 and configured to be coupled with wiring terminals of the control box 2.

As illustrated in FIG. 7, the control box 2 is detachably mounted on the protection frame 111 of the base frame 11, and the base frame 11 can be mounted on a vehicle body of a vehicle. Optionally, the control box 2 and the base frame 11 may be mounted separately on the vehicle body.

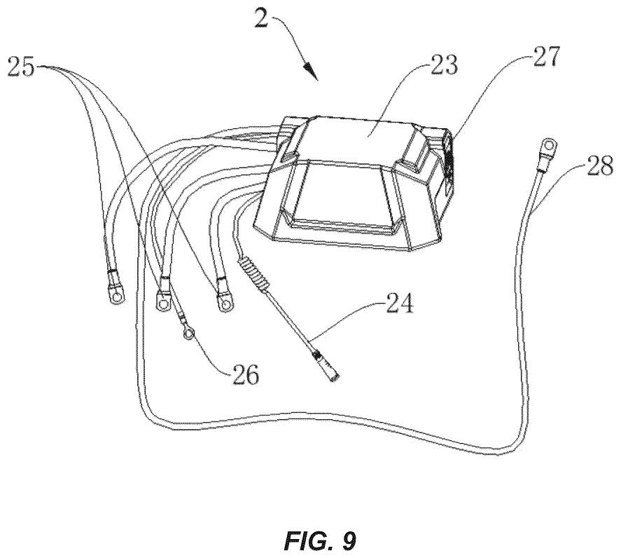

As illustrated in FIG. 9, the control box 2 includes a plurality of motor wires 25 having a first end and a second end. The first end of the motor wire 25 is arranged inside the box body 23, and the second end of the motor wire 25 is extended outside the box body 23. The plurality of motor wires 25 are configured to be correspondingly and removably insertable into the plurality of connection ports (not shown in the figure) of the motor 13, so that the control box 2 can control the start and stop of the motor 13 and a forward and reverse rotation of the motor 13. A length of the motor wire 25 can be selected according to a distance between the control box 2 and the motor 13.

As illustrated in FIG. 9, the control box 2 also includes a ground wire 26 having a first end and a second end, and a power source wire 28 having a first end and a second end. A first end of the ground wire 26 is arranged inside the box body 23, and the second end of the ground wire 26 is extended outside the box body 23 and is grounded. The ground wire 26 is configured to protect the control box 2, prevent electrostatic hazards, and ensure user safety. The first end of the power source wire 28 is arranged inside the box body 23, and the second end of the power source wire 28 is extended outside the box body 23 for coupling with a power source.

In some examples, as illustrated in FIGS. 7 to 10, there is one additional display 6. The control box 2 includes one additional wire 24 which has a first end and a second end 241. The first end of the additional wire 24 is arranged inside the box body 23, and the second end 241 of the additional wire 24 is extended outside the box body 23 and is configured to be detachably coupled with the additional display 6.

Optionally, there are a plurality of additional displays 6, and the control box 2 may include a plurality of additional wires 24. The plurality of additional wires 24 are coupled with the plurality of additional displays 6 one-to-one.

In the embodiment shown in FIG. 7, the additional display 6 includes a light plate 61 and an additional extension wire 62 having a first end and a second end. The light plate 61 includes a plurality of first lights 611 for displaying the load state of the motor 13. The first end of the additional extension wire 62 is coupled with the light plate 61, and the second end of the additional extension wire 62 is configured to be removably insertable into the second end 241 of the additional wire 24, thereby achieving signal connection between the control box 2 and the light plate 61.

Optionally, the second end of the additional extension wire 62 can be a female connector, and the second end 241 of the additional wire 24 can be a male connector. Alternatively, the second end of the additional extension wire 62 may be coupled with the second end 241 of the additional wire 24 in other ways known in the art and capable of achieving signal connection, which is not limited by the disclosure.

In order to facilitate the storage of connection wires, both the additional extension wire 62 and the additional wire 24 can be retractable wires. For example, as illustrated in FIG. 7, the additional extension wire 62 and the additional wire 24 both include spiral coils. Therefore, the additional extension wire 62 and the additional wire 24 can be extended or retracted as needed, which is more convenient to use.

In other examples, the second end 241 of the additional wire 24 can be exposed from the box body 23, and the second end of the additional extension wire 62 is configured to be detachably coupled with the second end 241 of the additional wire 24.

In other examples, the additional display 6 includes a light plate 61 with a signal port located on the light plate 61. The second end 241 of the additional wire 24 is extended outside the box body 23 and is configured to be detachably coupled with the signal port of the light plate 61.

As illustrated in FIG. 7, the light plate 61 of the additional display 6 includes a plurality of first lights 611, which are arranged in a straight line along the extension direction of the light plate 61 and spaced apart from each other. The plurality of first lights 611 are configured to indicate the load state of the motor 13 via at least one of illuminated first lights 611 or color of light emitted by the first lights 611. Moreover, the plurality of first lights 611 on the light plate 61 can have a certain lighting sequence. For example, the light plate 61 has opposite first and second ends in its extension direction, and the lighting sequence of the plurality of first lights 611 is to light up sequentially from the first end of the light plate 61 towards the second end of the light plate 61.

Optionally, the plurality of first lights 611 display the load state of the motor 13 via the quantity of the illuminated first light 611. For example, the larger the load on the motor 13, the more illuminated first lights 611 on the light plate 61, and the smaller the load on the motor 13, the fewer illuminated first lights 611 on the light plate 61. When all the first lights 611 on the light plate 61 are illuminated, it indicates that the motor 13 is in an overloaded state, and it is necessary to promptly stop the motor 13 from running or reduce the load on the motor 13, so as to protect the motor 13.

Optionally, the plurality of first lights 611 display the load state of the motor 13 via the color of light emitted by the first lights 611. For example, the first lights 611 can emit three different colors of light, namely green light, yellow light, and red light. When the first light 611 emits green light, it indicates that the motor 13 is in a mild load state and is running normally. When the first light 611 emits yellow light, it indicates that the motor 13 is in a moderate load state and is running normally. When the first light 611 emits red light, it indicates that the motor 13 is in an overload state, and it is necessary to promptly stop the motor 13 from running or reduce the load on the motor 13, so as to protect the motor 13.

Optionally, the plurality of first lights 611 display the load state of the motor 13 via the quantity of illuminated first lights 611 and the color of light emitted by the first lights 611. For example, the light plate 61 includes the first lights 611 in three colors, namely green light, yellow light and red light. There is at least one first light 611 in each color. The green light is arranged on a left side surface of the yellow light, and the red light is arranged on a right side surface of the yellow light. As the load on the motor 13 increases, the green light, the yellow light and the red light are lit up sequentially from left to right. When all the red lights are lit (e.g., on), it indicates that motor 13 is in an overloaded state, and it is necessary to promptly stop the motor 13 from running or reduce the load on the motor 13, so as to protect the motor 13.

In other embodiments, the display mode of the light plate 61 is not limited this. For example, the light plate 61 can be a light strip/light belt, which can display the load state of the motor 13 via at least one of a length or color of a brightness strip. The larger the load on the motor 13, the longer the length of the brightness strip, and the smaller the load on the motor 13, the shorter the length of the brightness strip. For another example, the light plate 61 can be a liquid crystal display screen, which is configured to display numbers indicating the load state of the motor 13.

In some embodiments, the winch device 100 further includes a control handle 4, which is wired to or wirelessly coupled with the control box 2 and configured to control an operation of the winch 1. The user holds the control handle 4 for more flexible and convenient operations. For example, the user can adjust the position at any time to facilitate observing the additional display 6, and operate promptly via the control handle 4 according to the load state of the motor 13 displayed on the additional display 6, which is flexible and convenient.

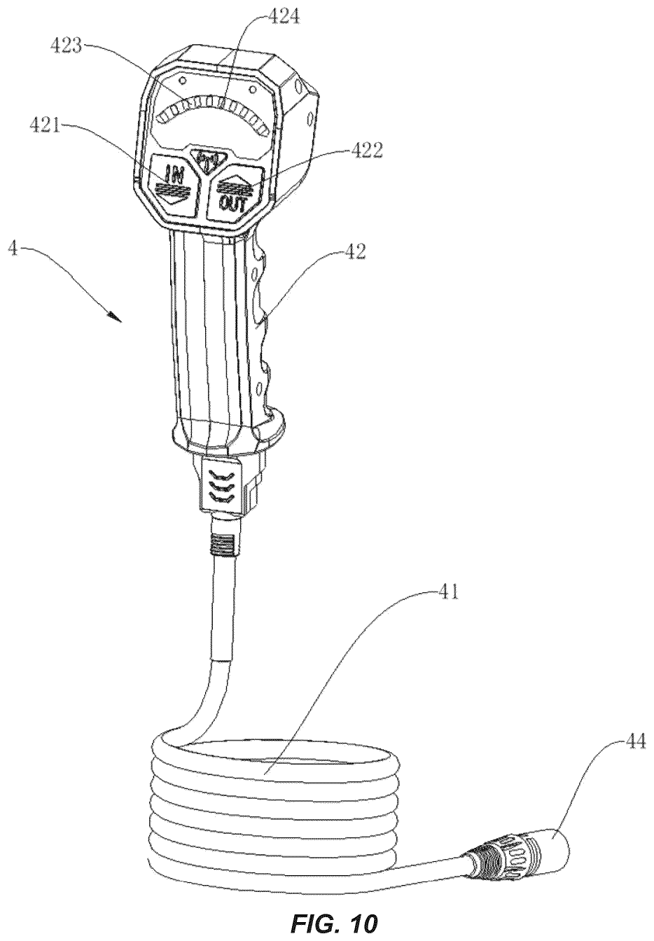

As an example, as illustrated in FIGS. 7 to 10, the control handle 4 is wired to the control box 2. As illustrated in FIG. 9, the control box 2 has a handle port 27. As illustrated in FIG. 10, the control handle 4 has a handle terminal 44, which can be removably insertable into the handle port 27.

As illustrated in FIG. 9, the handle port 27 is exposed from the box body 23. As illustrated in FIG. 10, the control handle 4 includes a handle body 42 and a handle wire 41 having a first end and a second end. The handle body 42 is equipped with several buttons or knobs and is configured to be held by the user to operate the winch 1. The first end of the handle wire 41 is extended into the handle body 42, and the second end of the handle wire 41 is extended outside the handle body 42 and provided with the handle terminal 44. When there is no need to use the control handle 4, the handle terminal 44 can be separated from the handle port 27.

Optionally, the handle port 27 can be extended outside the box body 23 via a wiring, and the handle terminal 44 can be exposed from the handle body 42 and configured to be removably insertable into the handle port 27.

Optionally, the control handle 4 can be wirelessly coupled with the control box 2 to control the operation of the winch 1. For example, the control handle 4 is equipped with a wireless signal transmission module for transmitting control signals, and the control box 2 is equipped with a wireless signal reception module for receiving control signals. When the user operates the control handle 4, the control handle 4 sends a wireless signal to the control box 2. After receiving the wireless signal, the control box 2 controls the operation of the winch 1.

As illustrated in FIG. 10, the handle body 42 has an IN button 421 and an OUT button 422. The user can press the IN button 421 to control the winch 1 to retract the rope, and press the OUT button 422 to control the winch 1 to release the rope wound on the rope drum 12. It is convenient and quick for users to operate. In other examples, buttons used for other operations can also be arranged on the handle body 42.

In order to make it more convenient for users to observe the load state of the motor 13, as illustrated in FIG. 10, a handle display 423 is arranged on the handle body 42 of the control handle 4 and is configured to display the load state of the motor 13. Users can observe the load state of the motor 13 from the control handle 4 while using the control handle 4, making the use of the winch device 100 more convenient.

In the example illustrated in FIG. 10, the handle display 423 has a dial shape Specifically, as illustrated in FIG. 10, the handle display 423 includes a plurality of second lights 424, which are arranged in an arc-shaped array, spaced apart from each other, and located above the IN button 421 and OUT button 422. The plurality of second lights 424 are configured to indicate the load state of the motor 13 via at least one of a quantity of illuminated second lights 424 or color of light emitted by the second lights 424. Moreover, the second light 424 on the handle display 423 may have a certain lighting sequence. For example, as illustrated in FIG. 10, the lighting sequence of the second light 424 is from left to right. In other examples, the lighting sequence of the second light 424 may be from right to left.

Optionally, the plurality of second lights 424 display the load state of the motor 13 via the quantity of the illuminated second lights 424. For example, the larger the load on the motor 13, the more illuminated second lights 424 on the handle display 423, and the smaller the load on the motor 13, the fewer illuminated second lights 424 on the handle display 423. When all the second lights 424 on the handle display 423 are illuminated, it indicates that the motor 13 is in an overloaded state, and it is necessary to promptly stop the motor 13 from running or reduce the load on the motor 13, so as to protect the motor 13.

Optionally, the plurality of second lights 424 display the load state of the motor 13 via the color of light emitted by the second lights 424. For example, the second light 424 can emit three different colors of light, namely green light, yellow light, and red light. When the second light 424 emits green light, it indicates that the motor 13 is in a mild load state and is running normally. When the second light 424 emits yellow light, it indicates that the motor 13 is in a moderate load state and is running normally. When the second light 424 emits red light, it indicates that the motor 13 is in an overload state, and it is necessary to promptly stop the motor 13 from running or reduce the load on the motor 13, so as to protect the motor 13.

Optionally, the plurality of second lights 424 display the load state of the motor 13 via the quantity of illuminated second lights 424 and the color of light emitted by the second lights 424. For example, the handle display 423 includes the second lights 424 in three colors, namely green light, yellow light and red light. There is at least one second light 424 in each color. The green light is arranged on a left side surface of the yellow light, and the red light is arranged on a right side surface of the yellow light. As the load on the motor 13 increases, the green light, the yellow light and the red light are lit up sequentially from left to right. When all the red lights are lit (e.g., on), it indicates that the motor 13 is in an overloaded state, and it is necessary to promptly stop the motor 13 from running or reduce the load on the motor 13, so as to protect the motor 13.

It should be noted that the arrangement mode of the plurality of second lights 424 of the handle display 423 is not limited to this. For example, in other embodiments, the plurality of second lights 424 can be arranged vertically on the handle body 42, and the lighting sequence of the second lights 424 can be from bottom to top. As the load level of the motor 13 increases, the second lights 424 are lit up sequentially from bottom to top.

In other embodiments, the display mode of the handle display 423 is not limited to this and can be other displays. For example, the handle display 423 can be a light strip/light belt, which can display the load state of the motor 13 via at least one of a length or color of a brightness strip. The larger the load on the motor 13, the longer the length of the brightness strip, and the smaller the load on the motor 13, the shorter the length of the brightness strip. For another example, the handle display 423 can be a liquid crystal display screen, which is configured to display numbers indicating the load state of the motor 13.

In some embodiments, as illustrated in FIG. 7, the winch device 100 further includes a fixed display 7 for displaying the load state of the motor 13. A fixed connection terminal (not shown in the figure) is arranged inside the control box 2, and the fixed display 7 is fixedly coupled with the fixed connection terminal. The fixed display 7 can be mounted on at least one of the base frame 11 or the box body 23. In the embodiment illustrated in FIG. 7, the fixed display 7 is a liquid crystal display screen, which can display numbers indicating the load state of the motor 13.

Optionally, the fixed display 7 can be mounted on the base frame 11.

A vehicle 200 according to an embodiment of the disclosure is described below.

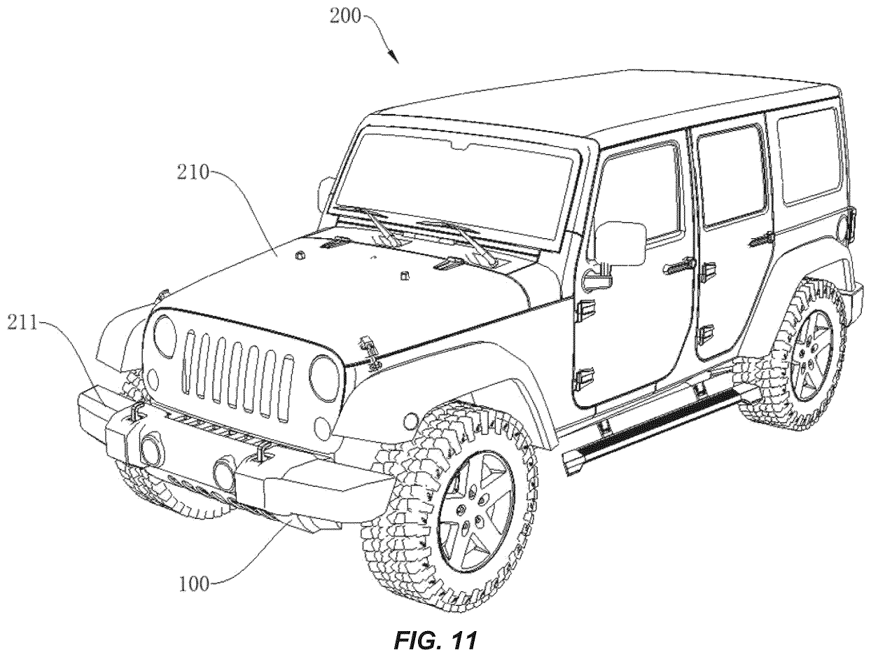

As illustrated in FIGS. 11 to 14, the vehicle 200 includes a vehicle body 210 and a winch device mounted on the vehicle body 210. The winch device is the winch device 100 in any of the above embodiments.

In some embodiments, the winch device 100 may be the winch device 100 illustrated in FIGS. 5-6. As an example, as illustrated in FIG. 11, the winch device 100 can be mounted below a front bumper 211 of the vehicle body 210.

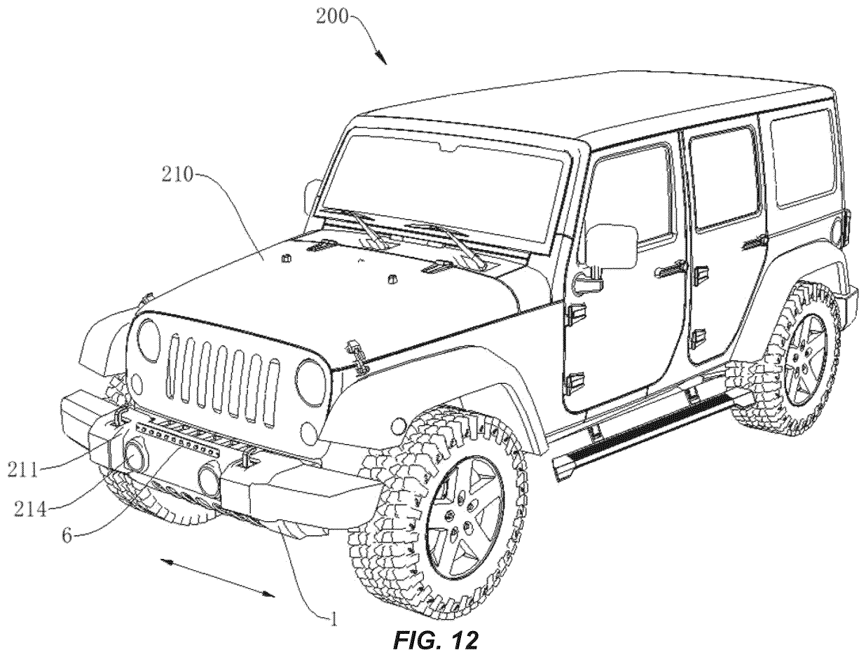

In some embodiments, the winch device 100 may be the winch device 100 illustrated in FIGS. 7-10. As an example, as illustrated in FIGS. 12-14, the additional display 6 is mounted on at least one of the base frame 11, the box body 23, or the vehicle body 210.

In some embodiments, the additional display 6 is mounted on at least one of the front bumper 211 of the vehicle body 210, a grille 212 of the vehicle body 210, and a hood 213 of the vehicle body 210.

As an example, as illustrated in FIG. 12, the additional display 6 is mounted on the front bumper 211 of the vehicle body 210. The additional display 6 is a light plate 61, and an extension direction of the light plate 61 is parallel to a width direction (such as the direction indicated by the arrow in FIG. 12) of the vehicle body 210. Users can directly observe the load state of the motor 13 displayed on the additional display 6 from the front of the vehicle 210.

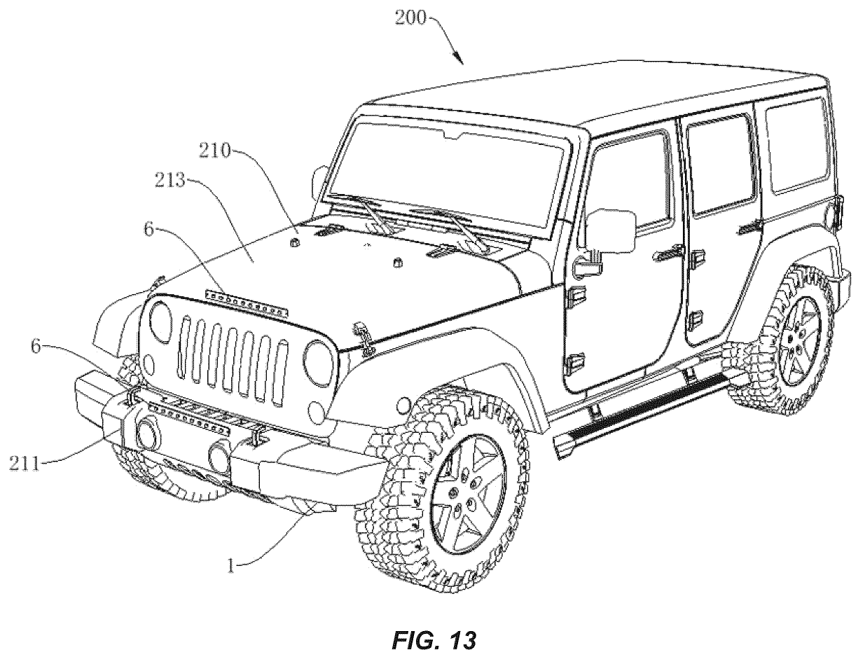

As an example, as illustrated in FIG. 13, the winch device 100 includes two additional displays 6, one of which is mounted on the hood 213 of the vehicle body 210, and the other additional display 6 is mounted on the front bumper 211 of the vehicle body 210.

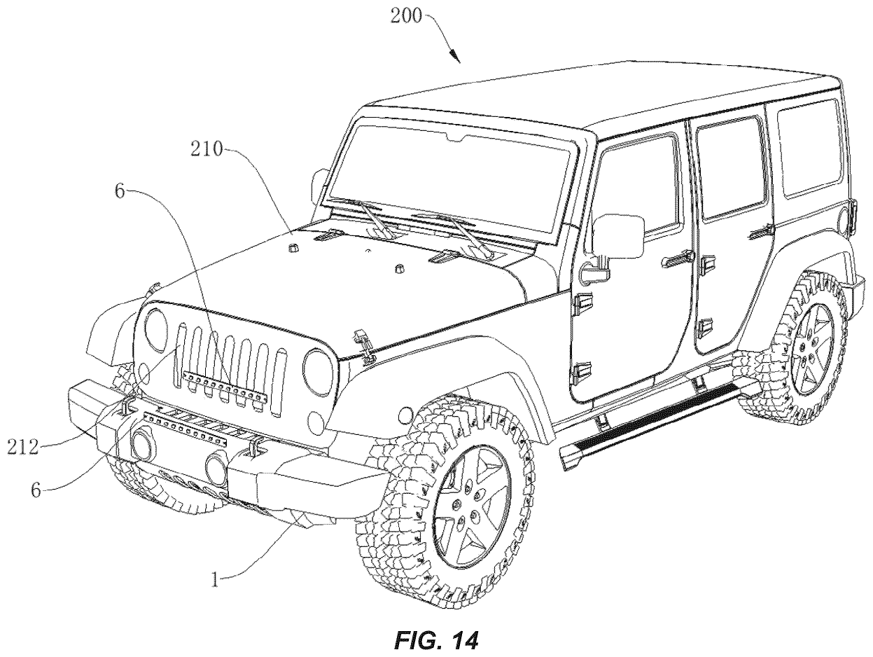

As an example, as illustrated in FIG. 14, the winch device 100 includes two additional displays 6, one of which is mounted on the grille 212 of the vehicle body, and the other additional display 6 is mounted on the front bumper 211 of the vehicle body 210.

Optionally, the additional display 6 can be detachably coupled with the vehicle body 210, and users can adjust the mounting position of the additional display 6 as needed.

For example, the additional display 6 is coupled with the vehicle body 210 by means of magnetic attraction. The additional display 6 is equipped with a first magnet, and at least one of the front bumper 211, the grille 212, or the hood 213 of the vehicle body 210 is equipped with a second magnet. The first magnet and the second magnet can be magnetically attracted together and separated by external force.

In some embodiments, the additional display 6 is mounted on the vehicle body 210 and serves as an illuminating light to supplement illumination when the motor 13 stops running. For example, as illustrated in FIG. 12, the additional display 6 is mounted on the front bumper 211 of the vehicle body 210 and is located above a front illuminating light 214 of the vehicle 200. When the winch device 100 is not needed, the plurality of first lights 611 of the additional display 6 can emit light to supplement illumination.

Optionally, the additional display 6 can also serve as an atmosphere light when the motor 13 stops running, for example, the plurality of first lights 611 of the additional display 6 can emit light in different colors.

### Conclusion

In the description of the disclosure, it should be understood that orientations or position relationships indicated by terms “central,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” etc. are based on the orientations or position relationships illustrated in the accompanying drawings, and are only for convenience of describing the disclosure and simplifying the description, rather than indicating or implying that devices or components referred to must have a particular orientation, be constructed and operated in the particular orientation. Therefore, such terms cannot be understood as a limitation on the disclosure.

In the disclosure, unless otherwise specified and limited, the terms “mount,” “couple,” “connect,” “fix,” and other terms should be broadly understood. For example, they may refer to a fixed connection, a detachable connection, or features that are integrated. They may also refer to a mechanical connection, an electrical connection, or features that are in communication with each other. Features may be directly coupled or indirectly coupled through an intermediate medium. There may be an internal connection of two components or an interaction relationship between two components, unless otherwise specified. For those of ordinary skill in the art, specific meanings of the above terms in the disclosure may be understood based on specific cases.

In the disclosure, unless otherwise specified and limited, the first feature is “above” or “below” the second feature, which means that the first feature may be in direct contact with the second feature, or the first feature may be in indirect contact with the second feature through an intermediate media. Moreover, if the first feature is “on,” “above,” or “on top of” the second feature, this means that the first feature is directly or diagonally above the second feature or simply indicates that the first feature is horizontally higher than the second feature. If the first feature is “under,” “below,” or “on the bottom of” the second feature, this means that the first feature is directly or diagonally below the second feature or simply indicates that the horizontal height of the first feature is less than that of the second feature.

In the disclosure, the terms “an embodiment,” “some embodiments,” “an example,” “specific examples,” or “some examples” mean that a specific feature, structure, material, or characteristic described in connection with embodiments or examples is included in at least one embodiment or example of the disclosure. In this specification, the illustrative expressions of the above terms do not necessarily refer to the same embodiments or examples. Moreover, the specific feature, structure, material, or characteristic described may be combined in any suitable manner in one or more embodiments or examples. In addition, those skilled in the art may connect and combine different embodiments or examples as well as features of different embodiments or examples described in this specification, without conflicting with each other.

Although embodiments of the disclosure have been shown and described above, it can be understood that the above embodiments are illustrative and cannot be understood as a limitation of the disclosure. Those of ordinary skill in the art can make changes, modifications, alternatives, and variations to the above embodiments within the scope of the disclosure.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A winch device, comprising:
a winch including a base frame, a rope drum rotatably mounted on the base frame, and a motor mounted on the base frame and coupled with the rope drum to drive the rope drum to rotate;
a switch configured to couple with a power source; and
a control box coupled between the motor and the switch and including a bridge relay for controlling the motor to rotate in a forward direction or a reverse direction,
wherein the switch comprises:
a housing,
a relay arranged in the housing and including a reset button for manually resetting the relay from outside the housing, and
a control board arranged in the housing and including a control chip, a timer, and a detection component, the detection component being configured to detect at least one of a current or a voltage of the relay,
wherein the control chip is configured to control the relay to open in response to a value of at least one of the current or the voltage detected by the detection component being lower than a preset value and to the timer having run for a preset period.

2. The winch device of claim 1, further comprising:
a control handle that is wired to or wirelessly coupled with the control box and configured to control an operation of the winch,
wherein the control handle includes a signal generator, and
wherein the control box includes a signal receiver communicating wirelessly with the signal generator.

3. A vehicle, comprising a vehicle body and the winch device of claim 1 mounted on the vehicle body.

4. A winch device, comprising:
a winch, including:
a base frame,
a rope drum rotatably mounted on the base frame, and
a motor mounted on the base frame and coupled with the rope drum to drive the rope drum to rotate; and
a control box coupled with the motor and including:
a box body,
a relay arranged in the box body to control the motor to rotate in a forward direction or a reverse direction, and
a load detection component arranged in the box body and configured to detect a load state of the motor,
wherein the control box includes at least one additional wire having a first end arranged inside the box body and a second end, the second end of the at least one additional wire being extended outside the box body or exposed from the box body, and being configured to be detachably coupled with an additional display to display the load state of the motor.

5. The winch device of claim 4, further comprising:
a control handle that is wired to or wirelessly coupled with the control box and configured to control an operation of the winch.

6. The winch device of claim 5, wherein the control box includes a handle port, and the control handle includes a handle terminal removably insertable into the handle port.

7. The winch device of claim 6, wherein the control handle includes a handle body and a handle display having a dial shape and arranged on the handle body to display the load state of the motor.

8. The winch device of claim 7, wherein the handle display includes a plurality of lights arranged in an arc-shaped array and spaced apart from each other, wherein the handle display is configured to indicate the load state of the motor via at least one of a quantity of illuminated lights or color of light emitted by the plurality of lights.

9. The winch device of claim 4, wherein the additional display includes a plurality of lights configured to indicate the load state via at least one of a quantity of illuminated lights or color of light emitted by the plurality of lights.

10. The winch device of claim 4, further comprising:
a fixed display mounted on at least one of the base frame or the box body of the control box and fixedly coupled with a fixed connection terminal arranged in the control box.

11. A vehicle, comprising a vehicle body and the winch device of claim 4 mounted on the vehicle body.

12. A switch, comprising:
a housing;
a relay arranged in the housing and including a reset button to manually reset the relay from outside the housing; and
a control board arranged in the housing and including a control chip, a timer, and a detection component, the detection component being configured to detect at least one of a current or a voltage of the relay.

13. The switch of claim 12, wherein the control board comprises a base panel on which the control chip, the timer, and the detection component are integrated.

14. The switch of claim 13,
wherein the relay comprises a first terminal, a second terminal, a third terminal, and a fourth terminal;
wherein the switch further comprises a wire-outgoing terminal and a wire-incoming terminal, the wire-incoming terminal having (i) a wire-incoming inner end arranged within the housing and coupled with the first terminal, and (ii) a wire-incoming outer end arranged outside the housing and configured to couple with a positive electrode of a power source, and the wire-outgoing terminal having (i) a wire-outgoing inner end arranged within the housing and coupled with the second terminal, and (ii) a wire-outgoing outer end arranged outside the housing and coupled with a control box,
wherein the fourth terminal is coupled with a negative electrode of the power source via a grounding wire; and
wherein the control board is coupled with the third terminal via a control wire and a detection wire.

15. The switch of claim 14, wherein the control board is coupled with the first terminal via a power supply wire of the control board and is coupled with the fourth terminal via a negative electrode wire, and wherein the reset button is coupled between the control board and the positive electrode of the power source.

16. The switch of claim 14, further comprising:
a wire-incoming connection member having a first end and a second end, and
a wire-outgoing connection member having a first end and a second end,
wherein the first end of the wire-incoming connection member is coupled with the wire-incoming outer end of the wire-incoming terminal, and the second end of the wire-incoming connection member is configured to couple with the positive electrode of the power source, and
wherein the first end of the wire-outgoing connection member is coupled with the wire-outgoing outer end of the wire-outgoing terminal, and the second end of the wire-outgoing connection member is coupled with the control box.

17. The switch of claim 16,
wherein each of the wire-incoming connection member and the wire-outgoing connection member is configured to have a cylindrical shape, extended parallel in a same direction from the housing, and spaced apart from each other with an interval therebetween,
wherein the wire-incoming outer end of the wire-incoming terminal is extended out of the housing from a first side of the housing, and the wire-outgoing outer end of the wire-outgoing terminal is extended out of the housing from a second side of the housing opposite to the first side, and
wherein an extending direction of each of the wire-incoming connection member and the wire-outgoing connection member is perpendicular to an extending direction of each of the wire-incoming terminal and the wire-outgoing terminal.

18. The switch of claim 14,
wherein the housing comprises a switch enclosure having a bottom surface and a side surface that are open, and a bottom plate detachably mounted onto the bottom surface of the switch enclosure to close the bottom surface of the switch enclosure; and
wherein the switch enclosure has a first side surface and a second side surface which are adjacent to the side surface, respectively,
wherein a first reinforcing platform being arranged on the first side surface to support the wire-incoming terminal, and
wherein a second reinforcing platform being arranged on the second side surface to support the wire-outgoing terminal.

19. The switch of claim 18, wherein the first terminal, the second terminal, the third terminal, and the fourth terminal face the bottom surface of the switch enclosure respectively, and wherein the reset button is exposed from a top surface of the switch enclosure.

20. The switch of claim 12, wherein the control chip is configured to control the relay to open in response to a value of at least one of the current or voltage detected by the detection component being lower than a preset value and to the timer having run for a preset period; and wherein in response to the value of at least one of the current or voltage detected by the detection component exceeding the preset value within the preset period, the control chip is configured to control the timer to restart timing.
